(19) United States
(12) Patent Application Publication
(10) Pub. No.: US 2008/0241657 A1
(43) Pub. Date: Oct. 2, 2008

(54) Coiled-cell lithium-ion battery having collector and/or contacts embedded in plastic

(75) Inventors: Karsten Rieck, Nordhausen (DE); Stefan Theuerkauf, Nordhausen (DE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Dilo Trading AG, Zug (CH)

(21) Appl. No.: 11/983,189

(22) Filed: Nov. 7, 2007

(30) Foreign Application Priority Data
Nov. 8, 2006 (DE) 10 2006 035414.1

(51) Int. Cl. H01M 10/36

(52) U.S. Cl. 429/122

(57) ABSTRACT

A coiled cell lithium-ion battery is provided with a plastic element, at least on the part of the end face of the cell coil on which the collector projects, to partially or completely embed the collector.

### CROSS REFERENCE TO RELATED APPLICATION

This application claims benefit of German Patent Application No. 10 2006 035414.1, filed Nov. 11, 2006.

### BACKGROUND

The present invention relates to a battery having a coiled cell, and especially to fixing and stabilizing the contact of the collector to the terminal. The battery may be a lithium-ion battery, and the terminal may be an axial post led through the cell housing.

In typical coiled cell lithium-ion batteries, the collector (diverter), preferably in the form of collector tabs, is directly contacted with a terminal post (pole feedthrough). For this purpose, the collector tabs are bent over in the direction of the terminal post situated centrally on the axial end (front) face of the cell coil. An elastic connection of the collector tabs to the terminal post, which subsequently forms the terminal of the battery, thus results. In the event of a strain being imposed on a typical lithium-ion battery by impact, shock, or vibration, the tabs contacted on the terminal post may thus also vibrate, so that signs of fatigue appear in the material over time. This frequently results in fracture or crumbling of the collector material.

In addition, the cell coil may move back and forth in the axial direction because of acceleration, so that it presses into the terminal post at the end face. This has the result that a short-circuit may occur in the cell coil, loss of contact of the collector tabs may occur, and therefore the internal resistance may increase and/or a short-circuit may occur via the cell housing.

### SUMMARY

The present invention is directed to an improvement of the overall construction of the lithium-ion battery of the coiled cell type to overcome or mitigate the above problems of typical lithium-ion batteries.

According to a first aspect of the present invention, a lithium-ion battery of the coiled cell type is provided, which comprises a terminal post on at least one of the axial ends of the cell coil, on which the collector projecting out of the cell coil at this end is contacted, in which at least the part of the end face of the cell coil from which the collector projects is covered by a plastic element. This may result in a longer service life of the cell, e.g., because of a reduction of contacting errors.

According to a second aspect of the present invention, a lithium-ion battery according to the first aspect of the present invention is provided, the collector being partially or completely embedded in the plastic element to avoid contacting errors.

According to a third aspect of the present invention, a lithium-ion battery according to one of the prior aspects is provided, in which the collector projecting on the face of the cell coil is implemented from one or more collector tabs. The contacting the collector tabs may result in good contacting with simultaneously improved efficiency of the production method.

According to a fourth aspect of the present invention, a lithium-ion battery according to one of the prior aspects is provided, in which the terminal post is provided with a collector contacting element, which extends around the terminal post on the front face side of the cell coil and is connected to the plastic element. This collector contacting element makes the permanent and durable contacting of the collector (tabs) easier by using linear contacting faces. It may thus contribute to improving the service life of the overall cell.

According to a fifth aspect of the present invention, a lithium-ion battery according to the fourth aspect is provided, in which the collector element terminates flush with the plastic element on the side diametrically opposite the cell coil. This flush termination may not only ease the housing of the finished cell element, but rather may reduce the mobility of the contacting points. This lower mobility may contribute to avoiding short-circuits.

According to a sixth aspect of the present invention, a lithium-ion battery according to one of the first three aspects is provided, in which the cell coil, the plastic element, and the collector contact element together form a cylindrical unit, in which the plastic element is optionally not implemented on the areas without projecting collector tabs. A compact overall unit may thus be achieved, which may result in a higher service life and fewer failure mechanisms.

According to a seventh aspect of the present invention, a lithium-ion battery according to one of the aspects three through six is provided, in which multiple collector tabs projecting out of the cell coil are partially bent over and contacted with one another, the tabs being laterally in contact with the collector contact element. This may result in a reduction of contact errors and avoidance of short circuits, by which, inter alia, good durability of the cell may be achieved.

It is to be understood that both the foregoing general description and the following detailed description are exemplary and explanatory and are intended to provide further explanation of the invention as claimed.

### BRIEF DESCRIPTION OF THE FIGURES OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1A shows a side view of a lithium-ion battery.

FIG. 1B shows a top view of the lithium-ion battery shown in FIG. 1A.

FIG. 2A shows the side view of the lithium ion battery shown in FIG. 1A having a plastic element.

FIG. 2B shows the top view of the lithium-ion battery shown in FIG. 2A.

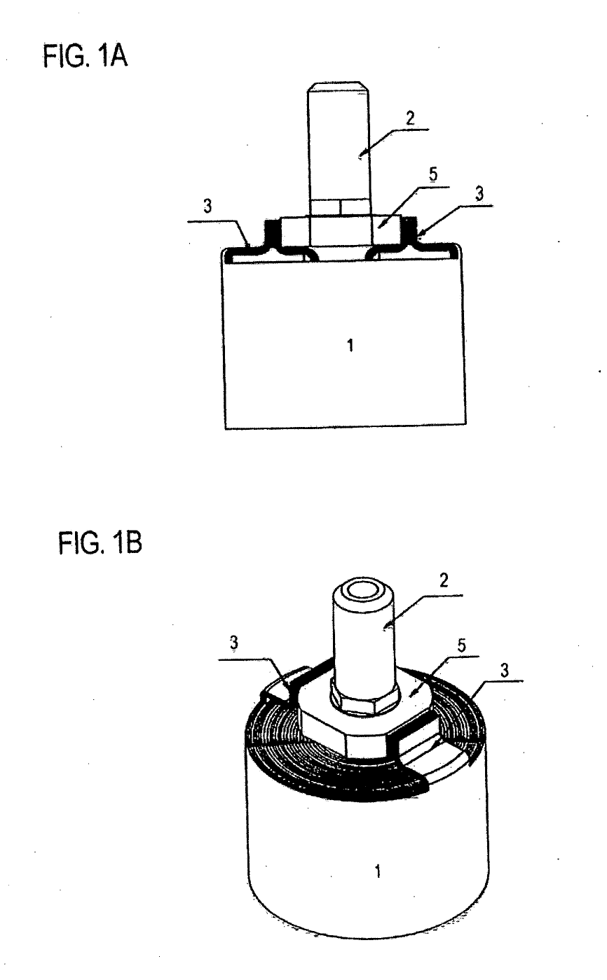

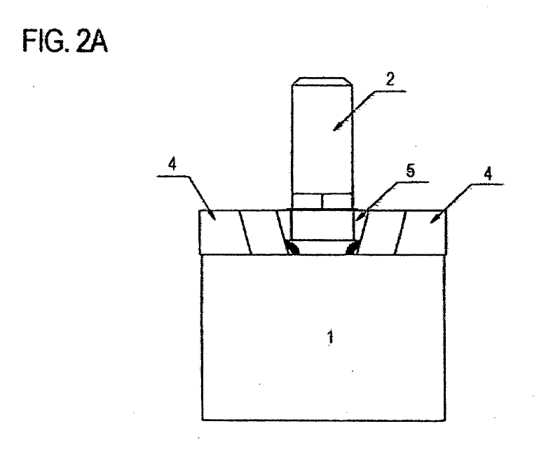

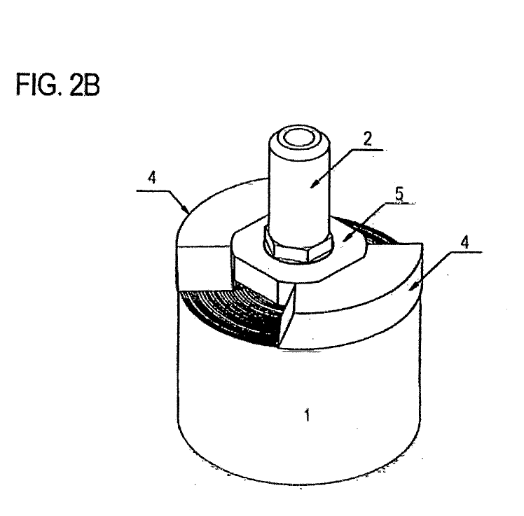

### DETAILED DESCRIPTION

Reference will now be made in detail to various embodiments of the present invention, examples of which are illustrated in the accompanying drawings. The embodiments are described by way of explanation, and not by way of limitation.

Referring to the accompanying drawings, one embodiment of a lithium-ion battery according to the present invention of the coiled cell type comprises a cell coil 1, a central terminal post 2 attached to at least one of the end faces (front sides) of the cell coil 1, and collectors 3 projecting out of the cell coil 1 on the front side. The collector tabs 3 projecting from the cell coil 1 on this front side are contacted to the terminal post 2. The collectors 3 may preferably also comprise individual collector tabs, which are arranged, for example, on diametrically opposite positions of the cell coil. These collector tabs 3 may be bent over more easily for contacting on the terminal post, because they do not extend out of the cell coil around the entire circumference. For security, multiple collector tabs 3 may project out of the cell coil. Contacting errors are thus prevented more easily.

In a preferred embodiment, the lithium-ion battery shown in the drawings may comprise a collector contacting element 4 on the terminal post, which is optionally situated centrally, for better contacting of the collector tabs 3, the element being provided around the centrally situated terminal post 2 and preferably comprising straight contacting faces on the side of the collector contacting element. Improved contacting of the spread and or bent-over collector tabs may thus be guaranteed. The contacting of the collector tabs on these preferably planar lateral faces of the collector contacting element may preferably be performed using welding, any known method also being able to be used as long as it allows solid contacting. Preferred methods for this purpose are an ultrasonic welding method and/or a spot welding method, for example.

The terminal post 2 is also used as a terminal of the lithium-ion battery after the cell coil 1, the collector contacting element 5, the collector 3, and the plastic element 4 are enclosed in a housing. Of course, the collectors may also be fixed and contacted at both ends of the cell coil.

According to the present invention, a plastic element 4 is provided on the front side of the cell coil 1 on at least the part of the surface of the cell coil 1 at which the collector projects out of the front side of the cell coil 1. The collector 3 is preferably partially or completely embedded in the plastic element 4 after it has been contacted to the terminal post 2 or the collector contacting element 5. To embed the collector or the collector tabs 3 in plastic, the plastic element 4 may be cast using a corresponding casting mold, so that the whole or a specific part of the end of the cell coil 1 including the collector tabs and the bottom part of the terminal post are enveloped using plastic. The plastic element 4 fixes the cell coil 1 on the terminal post 2, on which the collector 3 is contacted. A complete bundle thus results, which presses against the cell housing at the front sides.

Furthermore, it is preferable for the surface of the plastic element 4 and the surface of the collector contacting element 5 to terminate flush on the side away from the cell coil. The cell coil 1, the plastic element 4, and the collector contacting element 5 may thus together form a cylindrical unit, which may then be housed together as a complete unit. Optionally, the plastic element 4 may not be provided on the areas at which the collector(s) 3 do not project out of the cell coil, to ensure better heat dissipation, for example.

A feature important to the present embodiment is that the collector 3 and/or the collector tabs 3 are embedded fixed with the terminal post 2 and/or the collector contacting element 4, so that there is no longer an elastic connection within the cell. This fixing and stabilization of the cell coil with the collector tabs and the terminal post in the cell housing of the lithium-ion battery results in an improvement of the contacting of the collector with the terminal post. A better contact may thus be produced between the collector 3 and the terminal post 2 and/or the collector contacting element 4, because there is no longer an elastic connection within the cell. The cell coil may also be restrained from pressing axially into the terminal post in the event of an impact or shock.

As a result, there can be a significant reduction in short circuits in the cell coil and a significant decrease in breaking of the contact of the collector tabs by mechanical influences such as an impact or a vibration. Therefore, according to the present invention, a significant reduction of failure mechanisms because of external stresses on the battery cells may be achieved. In particular, the relative movements by impact, shock, and vibrations in the cell housing are reduced to a minimum. Signs of fatigue of the collector material, such as crumbling, also occur to a lesser degree.

For the materials for the plastic element 4, it is advantageous for a plastic having a melting temperature of not less than 120° C. to be used, for example, so that melting of the plastic element because of heating of the cells under strain may be precluded. Casting resins or reactive resins may preferably be used. Suitable examples of such plastic casting resins and/or reactive resins are found in the Kunststoff-Lexikon [Plastics Lexicon] 9th edition, Karl Hanser Verlag, Munich, pages 219 and 447.

The curing may be performed thermally or by UV and/or radiation curing, for example (see also Ullmann's Encyclopedia of Industrial Chemistry, Vol. 21, pages 398-453, VCH Verlag, Weinheim [1992]). Unsaturated resins based on polybutadienols, epoxy resins, and in particular silicone resins have been proven to be especially suitable. Examples of these materials are found in Ullmann's Encyclopedia of Industrial Chemistry, Vol. 24, pages 74-76, and their curing on pages 71-73 [1993].

In summary, it may be stated that the embodiments provide an improved lithium-ion battery of a coiled cell type, in which a plastic element is provided to partially or completely embed the collector at least on the part of the front side of the cell coil on which the collector projects out of the front side. The present invention is not restricted to lithium-ion batteries, but rather may also be applied in electrical cells used in other ways. Examples of these are described in DE 10341355 A, the disclosure of which is herein incorporated by reference in its entirety.

Various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A coiled-cell battery, comprising:
a terminal;
a collector projecting from an end face of the cell coil in electrical connection with the terminal; and
a plastic element that covers at least the part of the end face of the cell coil from which the collector projects, and in which the collector is partially or completely embedded.

2. The battery according to claim 1, which is a lithium-ion battery.

3. The battery according to claim 1, wherein the collector projecting from the end face of the cell coil comprises one or more collector tabs.

4. The battery according to claim 1, wherein the terminal comprises an axial terminal post provided with a collector contacting element that extends around the terminal post on the end face of the cell coil and is connected to the plastic element.

5. The battery according to claim 4, wherein the side of the collector contacting element facing away from the cell coil is flush with the plastic element.

6. The battery according to claim 4, wherein the cell coil, the plastic element, and the collector contacting element together form a unit that is at least partially cylindrical.

7. The lithium-ion battery according to claim 6, wherein the plastic element is omitted from at least some areas without projecting collector tabs.

8. The lithium-ion battery according to claim 4, further comprising a plurality of collector tabs projecting out of the cell coil, wherein at least some of the collector tabs are partially bent over and the collector tabs are contacted with one another, so that they are in contact laterally with the collector contacting element.
